(19) United States
(12) Patent Application Publication
(10) Pub. No.: US 2006/0213956 A1
(43) Pub. Date: Sep. 28, 2006

(54) Method for producing a wire connection

(75) Inventor: Shui Yuan Yu, Littau (CH)

Correspondence Address: MCCORMICK, PAULDING & HUBER LLP, CITY PLACE II, 185 ASYLUM STREET, HARTFORD, CT, 06103, US

(73) Assignee: Unaxis International Trading Ltd., Cham (CH)

(21) Appl. No.: 11/384,609

(22) Filed: Mar. 20, 2006

(30) Foreign Application Priority Data
Mar. 23, 2005 (CH) 538/05

(51) Int. Cl. B23K 31/00; B23K 31/02

(52) U.S. Cl. 228/180.5

(57) ABSTRACT

A method for producing a wire connection between a semiconductor chip and a substrate with which the end of a wire protruding out of a capillary of a Wire Bonder is melted into a wire ball, attached to a first connection point on the semiconductor chip, pulled out to the required length and attached to a second connection point on the substrate is characterized in that, after attaching the wire ball to the first connection point on the semiconductor chip the capillary is first raised by a predetermined distance D₁ and then moved by a predetermined distance D₂ in horizontal or inclined upward direction and in the direction towards the second connection point on the substrate. The distances D₁ and D₂ amount typically to once to twice the diameter of the wire.

### CROSS REFERENCE TO RELATED APPLICATION

Applicant hereby claims foreign priority under 35 U.S.C § 119 from Swiss Application No. 538/05 filed Mar. 23, 2005, the disclosure of which is herein incorporated by reference.

### FIELD OF THE INVENTION

The invention concerns a method for producing a wire connection between a semiconductor chip and a substrate by means of a Wire Bonder.

### BACKGROUND OF THE INVENTION

A Wire Bonder is a machine with which semiconductor chips are wired to a substrate after mounting. The Wire Bonder has a capillary at the tip of which a horn is clamped. The capillary serves to attach the wire to a connection point on the semiconductor chip and to a connection point on the substrate as well as to guide the wire between the two connection points.

In years gone by a multitude of methods for producing such wire connections have been developed that take into account the continuously changing demands. With a widely used standard method for producing wire loops between the connection point on the semiconductor chip and the connection point on the substrate the end of the wire protruding out of the capillary is first melted into a ball. The wire ball is then attached to the connection point on the semiconductor chip by means of pressure and ultrasound. In doing so, ultrasound from an ultrasonic transducer is applied to the horn. This process is called ball bonding. The wire is then pulled through to the required length, formed into a wire loop and soldered to the connection point on the substrate. This last process part is called wedge bonding. After attaching the wire to the connection point on the substrate, the wire is torn off and the next bonding cycle can begin. With both bonding processes the temperature to which the substrate is heated plays an important part.

The standard method is fast as it comprises a few, simple process steps. However it has the disadvantage that the “loop height” as it is known in the art is relatively large. Therefore, new methods were developed for applications with which a small loop height is necessary. A well-known method is the so-called “reverse looping”, with which a wire ball is first applied to the connection point on the semiconductor chip. On attachment, the wire ball is pressed flat, i.e. formed into a “bump”, and then the wire is torn off. The wire connection is then produced in that the end of the wire protruding out of the capillary is melted into a ball and then, in the opposite way to the standard method, the wire ball is firstly attached to the substrate, the wire pulled through to the required length, formed into a wire loop and attached to the “bump” on the semiconductor chip as a “wedge bond”.

In the U.S. patent application no. 2005-0167473, a method is described with which a “bump” is also first attached to the connection point on the semiconductor chip. Then however, the wire connection is produced as a so-called “wedge-wedge” wire connection with which the wire is first attached to the “bump” on the semiconductor chip, pulled out to the required length and then attached to the substrate.

From the U.S. Pat. No. 6,933,608 a method has become known with which on forming the wire loop the wire is first attached to the semiconductor chip and then to the substrate as with the standard method. After attaching the wire ball to the connection point on the semiconductor chip, the capillary is first raised, then moved in horizontal direction in the direction away from the second connection point on the substrate, raised further, moved back by the same distance in horizontal direction in the direction towards the second connection point on the substrate and then lowered whereby the additional loop formed in this way is pressed against the wire ball and connected to the wire ball. Subsequently, the capillary is raised again and the wire loop formed and completed as with the standard method.

### SUMMARY OF THE INVENTION

The object of the invention is to develop a method for producing a wire connection with a lower loop height that requires as little time as possible.

The method in accordance with the invention is based on the principle of the standard method for producing a wire connection between a semiconductor chip and a substrate with which the end of the wire protruding out of the capillary of a Wire Bonder is melted into a wire ball, attached to a first connection point on the semiconductor chip, pulled out to the required length and attached to a second connection point on the substrate. The method is characterized in that after attaching the wire ball to the first connection point on the semiconductor chip the capillary is first raised by a predetermined distance D₁ and then moved by a predetermined distance D₂ in horizontal or inclined upward direction in the direction towards the second connection point on the substrate.

With a further development of the method, after carrying out these steps the capillary is a second time raised by a predetermined distance D₃ in vertical direction and then moved by a predetermined distance D₄ in horizontal or inclined upward direction and in the direction towards the second connection point on the substrate in order to bend the wire directly adjacent the attachment point on the semiconductor chip in such a way that the piece of wire runs parallel to the surface of the substrate.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale. In the drawings:

FIGS. 1, 2 show the path of the capillary in accordance with a first or second embodiment of the method in accordance with the invention,

FIG. 3 shows a wire loop formed according to this method,

FIGS. 4, 5 show the path of the capillary in accordance with a third or fourth embodiment of the method in accordance with the invention, and

FIG. 6 shows a wire loop formed according to this method.

### DETAILED DESCRIPTION OF THE PREFERRED EMBODIMENTS

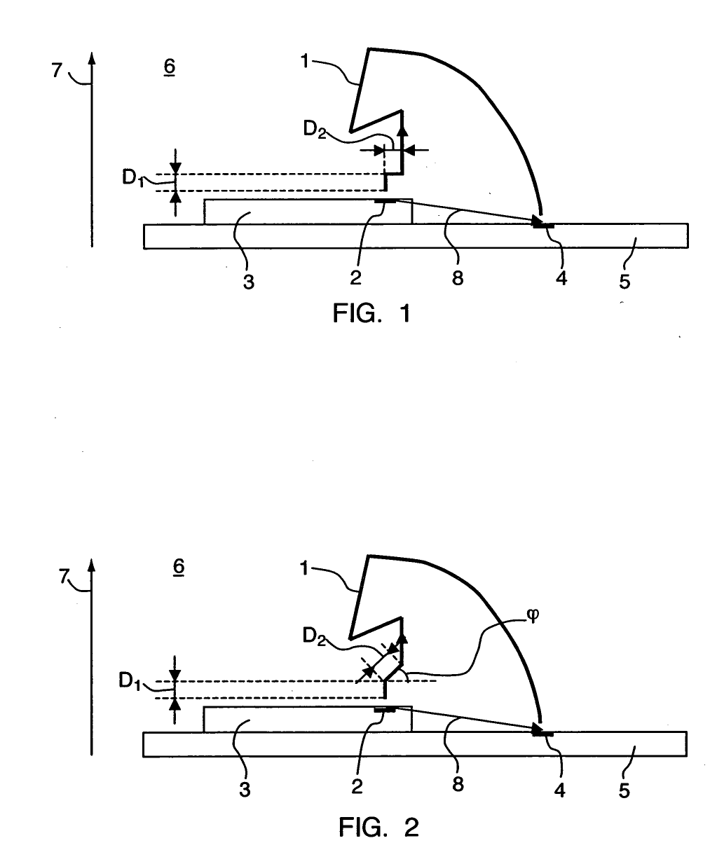

FIG. 1 shows the path 1 of the capillary in accordance with a first embodiment of the method in accordance with the invention for the production of a wire loop between a first connection point 2 on a semiconductor chip 3 and a second connection point 4 on a substrate 5. The travel movements take place in a plane 6 that is formed by the vertical 7 and a vector 8 that connects the two connection points 2 and 4. Production of the wire connection takes place according to the following process steps:
1. The end of the wire protruding out of the tip of the capillary is melted into a wire ball and attached to the first connection point 2 on the semiconductor chip 3.
2. The capillary is raised by a predetermined distance D₁, i.e. moved by the distance D₁ in vertical direction.
The distance D₁ amounts typically to once to twice the diameter of the wire. With a wire diameter of 25 μm, the distance D₁ therefore amounts to around 25 to 50 μm.
3. The capillary is moved by a predetermined distance D₂ in horizontal direction and in the direction towards the second connection point 4 on the substrate 5.
The distance D₂ also amounts typically to once to twice the diameter of the wire.

The process steps 2 and 3 have the effect that the wire is bent by 90° directly next to the deformed wire ball attached to the first connection point and therefore, unlike with the standard method described in the introduction, already runs directly above the attachment point in almost horizontal direction towards the second connection point 4 on the substrate 5.
4. The capillary is moved further in a conventional way, for example along the path presented in FIG. 1 with which the travel movements contain pulling the wire out to the required length and the formation of a kink.

FIG. 2 shows the path 1 of the capillary in accordance with a second embodiment of the method in accordance with the invention. The steps 1, 2 and 4 are the same as for the first embodiment. Step 3 is replaced by the following step:
3′. The capillary is moved by a predetermined distance D₂ in inclined upward direction and in the direction towards the second connection point 4 on the substrate 5.
The distance D₂ also amounts typically to once to twice the diameter of the wire.

The difference between the two embodiments therefore exists in that with the second type, in step 3′ the capillary is not moved in horizontal direction but simultaneously in horizontal and upwards in vertical direction, i.e. diagonally. The path describes an angle φ with the horizontal that typically amounts to 30 to 45°.

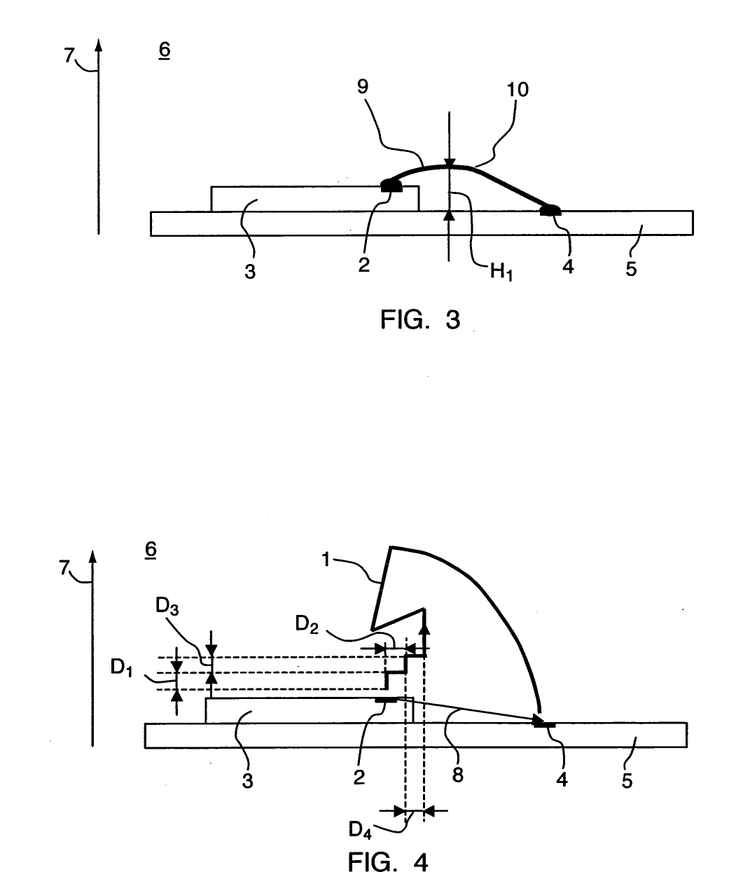

FIG. 3 shows a side view of a wire loop 9 formed with the method in accordance with the invention with which a conventional kink 10 was also formed in step 4. The piece of wire between the semiconductor chip 3 and the kink 10 tends to run not horizontally but curved. The loop height H₁ is therefore somewhat larger than the theoretical possible minimum loop height. Therefore, in accordance with the invention, a further embodiment is suggested with which an additional process step is carried out after step 3 and before step 4 in order to form an additional kink relatively close to the first connection point 2 thanks to which the piece of wire between this additional kink and the conventional kink 10 runs almost horizontally or even lightly inclined downwards. FIGS. 4 and 5 show two examples for the path 1 of the capillary when the first embodiment is expanded with this additional process step. The additional process step consists in that, after process step 3 or 3′ the capillary is raised by a predetermined distance D₃ and is then moved by a predetermined distance D₄ in horizontal direction (FIG. 4) or in inclined upward direction (FIG. 5) and in the direction towards the second connection point 4 on the substrate 5. However, it must be noted that the additional kink is hardly perceivable with the naked eye and, instead of an additional kink, one could also only speak of an additional, slight bending of the wire. The distance D₃ determines the distance of the additional kink from the first connection point 2: The greater the distance D₃, the further the additional kink is removed from the first connection point 2. The distance D₄ determines the strength of the additional kink and therefore the extent of the bend at the kink. The path 1 of the capillary shown in FIG. 2 can be modified in the same way.

In other words, the expansion described can be described in that the vertical movement of the capillary at the start of the process step 4 is interrupted en route in order to insert a short horizontal or inclined upward movement that is aligned in the direction towards the second connection point 4 on the substrate 5.

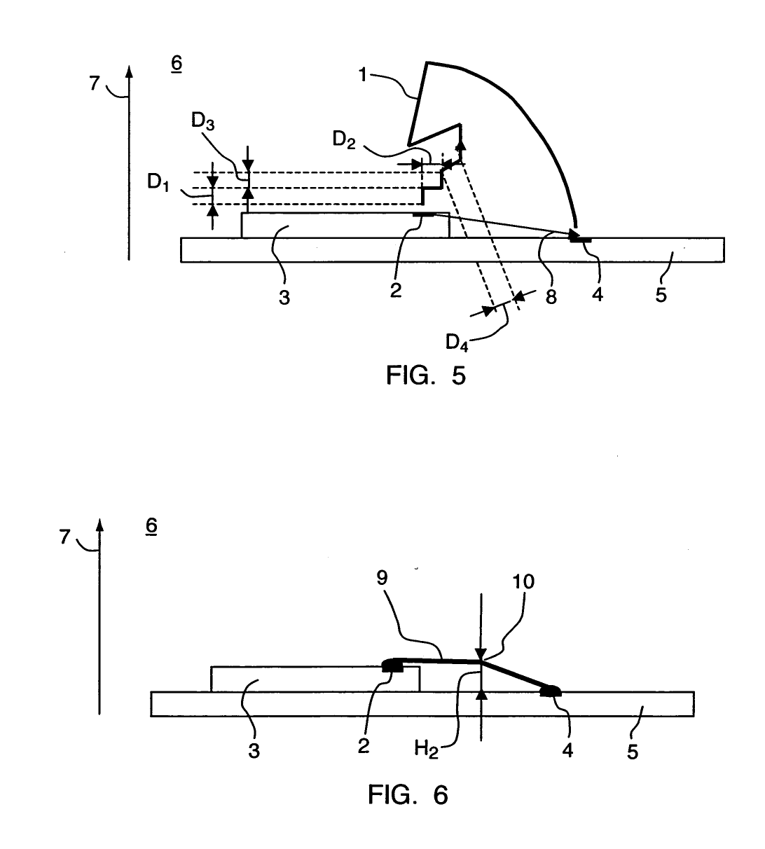

FIG. 6 shows a wire loop 9 produced with this expanded method with which the piece of wire between the connection point 2 on the semiconductor chip 3 and the conventional kink 10 runs horizontally. The distance D₃ is selected comparatively short so that the additional kink is located close to the first connection point 2. The loop height H₂ is therefore less than the loop height H₁.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. Method for producing a wire connection between a semiconductor chip and a substrate according to the steps of:
a) melting an end of a wire protruding out of a capillary of a Wire Bonder into a wire ball,
b) attaching the ball to a first connection point on the semiconductor chip,
c) raising the capillary by a predetermined distance D₁, the distance D₁ amounting to a value of once to twice a diameter of the wire,
d) moving the capillary by a predetermined distance D₂ in horizontal or inclined upward direction and in direction towards the second connection point on the substrate, the distance D₂ amounting to a value of once to twice the diameter of the wire,
e) raising the capillary and moving the capillary for forming a wire loop and attaching the wire to a second connection point on the substrate.

2. Method according to claim 1, further comprising the steps of
f) raising the capillary by a predetermined distance D₃ in vertical direction, and
g) moving the capillary by a predetermined distance D₄ in horizontal or inclined upward direction and in direction towards the second connection point on the substrate, the steps f and g performed after step d and before step e.

3. Method according to claim 2, wherein the distance D₃ amounts to a value of once to twice the diameter of the wire.

4. Method according to claim 3, wherein the distance D₄ amounts to a value of once to twice the diameter of the wire.
